(19) United States
(12) Patent Application Publication
(10) Pub. No.: US 2002/0075576 A1
(43) Pub. Date: Jun. 20, 2002

(54) Structure for reducing optical beam spacing

(75) Inventors: Li Wu, Fuxing Investment District (CN); Jiwu Ling, Fuxing Investment District (CN); Xueqin Huang, Fuxing Investment District (CN); Derong Lin, Fuxing Investment District (CN); Cuilian Zhan, Fuxing Investment District (CN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 10/012,945

(22) Filed: Dec. 10, 2001

(30) Foreign Application Priority Data
Dec. 14, 2000 (CN) 00261984.9

(51) Int. Cl. G02B 5/04; G02B 5/08

(52) U.S. Cl. 359/834; 359/857

(57) ABSTRACT

Parallel optical beams emitted by an array of optical devices e.g. collimators are spaced by a distance that is not smaller than the diameter of the collimators etc. devices. To reduce the spacing of the beams at the point of incidence on the receiving element or device, a structure is provided having a first and a second array of reflective surfaces e.g. mirrors or prisms, the arrays defining pairs of corresponding reflective surfaces. The surfaces are arranged such that the beams reflected from the second array have a reduced spacing compared to the initial distance.

### RELATED APPLICATIONS

This application claims priority from Chinese patent application No. 261984.9 filed Dec. 14, 2000.

### TECHNICAL FIELD

This invention relates to optical devices, and more particularly, to a structure and method for reducing the spacing between adjacent optical beams in a beam array, e.g. a beam array provided by a plurality of optical collimators.

### BACKGROUND OF THE INVENTION

It is common in the field of optical communications to use an array of optical beams delivering channels of information from an input device to an output device. As space is usually of concern in optical systems and miniaturization is constantly sought, especially to lessen the overall amount and cost of materials, it is desirable to keep the spacing between the optical beams in such array to a minimum, limited only by the specifics of the input and output element or device. It is known that the transmission of large optical beams requires relatively large components such as collimators, splitters, crystals, lenses etc. the cost of which can grow exponentially with diameter. However, output elements or devices, e.g. lasers or collimators, have also certain size requirements, and the minimum spacing between the emitted beams cannot be less than the diameter of the emitting device if the devices are disposed side by side. In other words, the axial diameter (in the beam direction) of the emitting device limits the minimum spacing between adjacent beams produced by the emitters in question. If the size of the beam emitter or output device (e.g. collimator) rather than the optical properties of the beam receptor is the critical factor, it is desirable to minimize the spacing between the optical beams emitted by the collimators etc. The above assumes that the beams in the beam array are substantially parallel so that the adjacent beam spacing at the emitting device ports practically equals the beam spacing at the receptor ports.

### SUMMARY OF THE INVENTION

In accordance with the invention, there is provided a structure for reducing the spacing between optical beams passing from a plurality of emitting elements or devices (hereinafter called “emitters”) arranged in an array with a spacing L1 between adjacent emitters, to a receiving element or device (hereinafter called “receptor”), the structure comprising:

a plurality of first reflecting surfaces and a corresponding plurality of second reflecting surfaces, the first reflecting surfaces each disposed to receive an optical beam from one of the plurality of emitters and to reflect the optical beam towards a corresponding one of the second reflecting surfaces,

the second reflecting surfaces each disposed to receive an optical beam from a corresponding first reflecting surface and to reflect the optical beam towards the receptor, wherein the second reflecting surfaces are disposed such that beams reflected therefrom towards the receptor are spaced by a distance L2 which is smaller than the distance L1.

If the structure is designed such that the beams passing between the second reflecting surfaces and the receptor are parallel to each other, the size of the second reflecting surfaces as seen in the direction of the receptor and their spacing in the same direction does not exceed the distance L2 so as not to obscure the adjacent light beams.

In accordance with another aspect of the invention, there is provided a method of reducing the spacing between optical beams passing from a plurality of output devices, or emitters arranged in an array with a spacing L1 between adjacent emitters, to an input device or element (“receptor”), the method comprising:

directing each beam outputted from one of the emitters to undergo a reflection at a first reflective surface followed by a reflection at a corresponding second reflective surface, each of the first reflective surfaces and corresponding second reflective surfaces disposed such that each beam reflected from the second reflective surface is directed towards the receptor, the size of the second reflective surfaces and their respective spacing, both as seen in a direction of the receptor, do not exceed a spacing L2 which is smaller than L1.

### BRIEF DESCRIPTION OF THE DRAWINGS

The invention will be explained in more detail by way of the following description to be taken with the accompanying drawings in which:

FIG. 1 is a schematic view of an optical device with a number of input ports and output ports,

FIG. 2 is a schematic view of a partial array of light beam emitters,

FIG. 3 illustrates an optical arrangement with a beam spacing reducing structure of the invention, and

FIG. 4 illustrates an exemplary positioning of reflective elements of the structure of the invention.

### DETAILED DESCRIPTION OF THE INVENTION

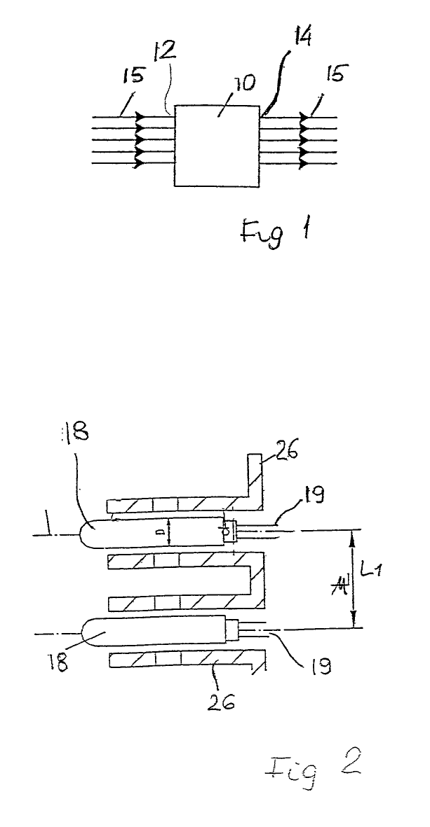

FIG. 1 illustrates an exemplary receptor, a multiple input device such as a 5×5 switch 10 with five input ports 12 and five output ports 14. The corresponding light beams 16 coupled to the input ports and outputted from the output ports are passed in free space or through optical fibers 15 from an array of collimators 18 shown in FIG. 2.

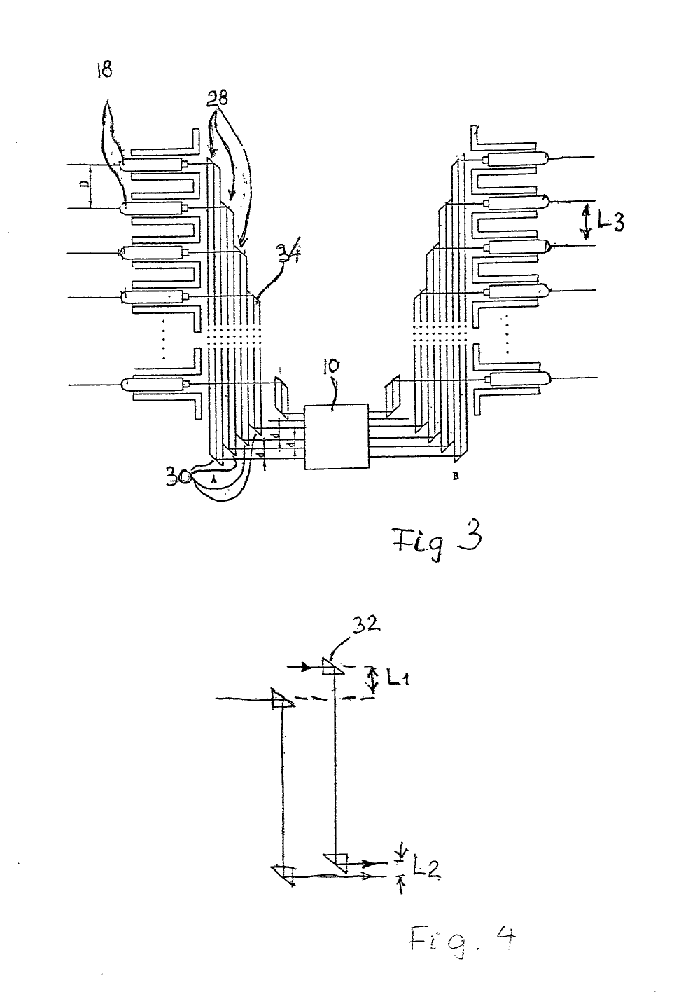

As shown schematically in FIG. 2 and FIG. 3, an array of collimators 18 may be arranged with the collimators side-by-side for space saving. It is of course possible to arrange the collimators in a different array, still with a view to outputting optical beams with a minimal spacing therebetween.

Each collimator 18 has a holder 26. The diameter of the collimator and the size of the holder determine the minimum spacing between the centers of the collimators which corresponds to the spacing L1 between adjacent collimated optical beams 19 emitted from the collimators. Typically, the beams are parallel to each other. To reduce the spacing of the beams at their incidence on the receptor (e.g. isolator) 10, an array of mirrors 28, 30 is provided. The array of mirrors includes a first sub-array of mirrors 28 and a second sub-array of mirrors 30. As seen in FIG. 3, the mirrors of the sub-array 28 are disposed at an angle 450 to the optical beams emitted from the collimators 18 so as to reflect the beams towards respective mirrors of the sub-array 30. The mirrors 28 are spaced such as to correspond to the spacing L1 between the collimators.

As shown in FIG. 4, the mirrors of the sub-array 30 are spaced “horizontally” to receive respective optical beams reflected from the mirrors 28, but their spacing L2 as seen in the direction towards the receptor (horizontal in FIG. 4) is smaller than L1. This beneficial result is of course dependent on the size of the mirrors 30 so that they do not obscure the adjacent light beams.

It is not necessary for the reflective surfaces of the mirrors 28 and 30 to be disposed at 45° to the incident light beams, but such arrangement may be advantageous for various reasons.

The mirrors 28 and 30 may be provided by prisms 32 (FIG. 4) with reflective surfaces that cause total internal reflection of the light beams within the prisms. Alternatively, as illustrated in FIG. 3, prisms 34 may extend the entire distance (vertical in FIG. 3) between the optical axes of the respective collimators and the optical axes of the beams reflected from the respective mirrors 30. Thus, the prisms function as waveguides, each waveguide having a first reflective surface and a second reflective surface opposite the first reflective surface and parallel thereto. As a result, for most of their optical path, the optical beams are guided e.g. in a glass waveguide that has two reflective surfaces at the respective ends. The advantage of such arrangement over free space travel of the optical beams is that the respective optical paths of the light beams can be adjusted e.g. by varying the refractive indexes of the respective prisms/waveguides 34. In one embodiment of the invention, illustrated in FIG. 3, the structure has n prisms, the number corresponding to the number of output elements (collimators) and the input ports on the device 10. The prisms are arranged in parallel and are of different length selected to reduce (left-hand part of FIG. 3) or expand (right-hand part of FIG. 3) the spacing between a plurality of optical beams outputted from the output devices (collimators) 18.

As further shown in the right-hand side of FIG. 3, the arrangement of the invention can be reversed such that the relatively small spacing L2 of the optical beams emitted from the device 10 is converted, through an arrangement of first and second reflective surfaces, into a larger spacing L3, suitable to accommodate the spacing of receiving devices 40.

The above examples are for illustrative purposes and not intended to limit the scope of the invention which is to be interpreted solely by the appended claims. For example, the prisms 32 and 34 may be replaced by other optical elements having the respective reflective surfaces.

1. A structure for reducing a spacing between optical beams passing from a plurality of emitters to a receptor, wherein adjacent emitters are spaced from each other by a spacing L1, the structure comprising:
a plurality of first reflecting surfaces and a corresponding plurality of second reflecting surfaces, the first reflecting surfaces each disposed to receive an optical beam from one of the plurality of emitters and to reflect the optical beam towards a corresponding one of the second reflecting surfaces,
the second reflecting surfaces each disposed to receive an optical beam from a corresponding first reflecting surface and to reflect the optical beam towards the receptor, wherein the second reflecting surfaces are disposed such that beams reflected therefrom towards the receptor are spaced by a spacing L2 which is smaller than the spacing L1.

2. The structure according to claim 1 wherein the reflecting surfaces are disposed such that the optical beams between the second reflecting surfaces and the receptor are parallel to each other.

3. The structure according to claim 2 wherein the size of the second reflecting surfaces as seen in the direction of the receptor and their spacing in the same direction does not exceed the spacing L2 so as not to obscure adjacent light beams.

4. The structure according to claim 1 wherein the first reflective surfaces and the second reflective surfaces are prism surfaces.

5. The structure according to claim 1 wherein the first reflective surfaces and the second reflective surfaces are mirrors.

6. The structure according to claim 4 comprising a plurality of prisms, each of the prisms having a first reflective surface and a second reflective surface opposite the first reflective surface.

7. The structure according to claim 6 wherein the prisms are parallel to each other and are of varying length selected to reduce or expand spacing between optical beams passing between the emitters and the receptors.

8. A system comprising
at least one optical module having a number of input/output ports for transmitting a corresponding number of optical beams between the input ports and the output ports, and
a plurality of optical elements having each a first reflective surface and a second reflective surface, the prisms having varying lengths selected for receiving optical beams from the output ports and reflecting them to the input ports and for reducing or expanding the spacing between adjacent beams between the input ports and the output ports.

9. The system of claim 8 wherein the optical elements are prisms.

10. The system of claim 9 wherein the prisms are parallel to each other.

11. A method of reducing the spacing between optical beams passing from a plurality of emitters to a receptor, the emitters each spaced by a spacing L1, the method comprising:
directing each beam outputted from one of the emitters to undergo a reflection at a first reflective surface followed by a reflection at a corresponding second reflective surface, each of the first reflective surfaces and corresponding second reflective surfaces disposed such that each beam reflected from the second reflective surface is directed towards the receptor, the size of the second reflective surfaces and their respective spacing, both as seen in a direction of the receptor, not exceeding a spacing L2 which is smaller than L1.
